(19) United States
(12) Patent Application Publication
(10) Pub. No.: US 2018/0290531 A1
(43) Pub. Date: Oct. 11, 2018

(54) VEHICLE LOWER SECTION STRUCTURE

(71) Applicant: TOYOTA JIDOSHA KABUSHIKI KAISHA, Toyota-shi (JP)

(72) Inventor: Satoshi AJISAKA, Okazaki-shi (JP)

(73) Assignee: TOYOTA JIDOSHA KABUSHIKI KAISHA, Toyota-shi (JP)

(21) Appl. No.: 15/935,714

(22) Filed: Mar. 26, 2018

(30) Foreign Application Priority Data
Apr. 5, 2017 (JP) 2017-07 5495

(51) Int. Cl. B60K 1/04; B60L 11/18

(52) U.S. Cl. CPC B60K 1/04; B60L 11/1879; B60Y 2306/01; B60K 2001/0438; B60K 2001/0433

(57) ABSTRACT

A vehicle lower section structure includes rockers that are configured to be disposed at both vehicle width direction ends of a vehicle and that extend along a vehicle front-rear direction; a floor panel that includes plural floors in which a vehicle rear side thereof set higher than a vehicle front side thereof in a vehicle vertical direction, and a step portion formed between the floors that are adjacent to each other in the vehicle front-rear direction; a battery pack that is configured to be installed at a vehicle lower side of the floor, an upper portion of the battery pack including a step corresponding to the step portion of the floor panel; and a cross member that forms a cross portion having a closed cross-section together with the step portion and the floor, the cross portion extending along the vehicle width direction and coupling between the rockers.

### CROSS-REFERENCE TO RELATED APPLICATION

This application is based on and claims priority under 35 USC 119 from Japanese Patent Application No. 2017-075495 filed on Apr. 5, 2017, the disclosure of which is incorporated by reference herein.

### BACKGROUND

### Technical Field

The present disclosure relates to a vehicle lower section structure.

### Related Art

In vehicle types in which a battery pack is disposed below a floor panel, such as in electric automobiles, the mass of the battery pack is large. Therefore, in a collision, a large inertial force accordingly acts on the battery pack, so suppressing deformation to a vehicle cabin positioned above the battery pack becomes an issue.

For example, there is a concern that a predetermined battery pack capacity might not be obtained if side frames are simply separated from the battery pack by a distance in a vehicle width direction in order to secure a crushable stroke such that a vehicle body deforms in the vehicle width direction and absorbs energy in a side collision.

As in Japanese Patent Application Laid-Open (JP-A) No. 2013-67334, a configuration has been proposed in which side frames and vehicle width direction outer ends of a battery pack are coupled together using brackets, and a floor panel and a vehicle width direction inner end of the battery pack are coupled together by a deformable bracket. The deformable bracket deforms due to collision load being input from a vehicle width direction outer side, such that the vehicle width direction inner end of the battery pack moves downward. This causes the floor panel to deform so as to enable a crushable stroke to be secured, and the vehicle width direction inner end of the battery pack is configured so as not to impinge on other components as a result of deformation of the floor panel.

However, in the above configuration, there is room for improvement in the point of dispersing collision load acting on the battery pack into the vehicle body.

### SUMMARY

In consideration of the above circumstances, the present disclosure provides a vehicle lower section structure for a vehicle installed with a battery pack below a floor panel, in which the vehicle lower section structure disperses collision load acting on the battery pack during a collision.

An aspect of the present disclosure is a vehicle lower section structure including rockers that are configured to be disposed at both vehicle width direction ends of a vehicle and that extend along a vehicle front-rear direction; a floor panel that includes plural floors in which a vehicle rear side thereof set higher than a vehicle front side thereof in a vehicle vertical direction, and a step portion formed between the floors that are adjacent to each other in the vehicle front-rear direction; a battery pack that is configured to be installed at a vehicle lower side of the floors, an upper portion of the battery pack including a step corresponding to each of the step portions of the floor panel; and a cross member that forms a cross portion having a closed cross-section together with the step portion and the floor, the cross portion extending along the vehicle width direction and coupling between the rockers.

In the vehicle lower section structure according to the aspect, the plural floors including the vehicle rear side set higher than the vehicle front side are provided at the floor panel. Further, the step portion is formed between adjacent of the plural floors that are adjacent to each other in the vehicle front-rear direction. Moreover, the cross member is disposed extending along the vehicle width direction, and forms the cross portion having a closed cross-section configured by the step portion, the floor, and the cross member. The cross portion couples between the pair of rockers disposed at both vehicle width direction ends of the vehicle and extending along the vehicle front-rear direction.

The battery pack is installed below the floor panel, and the upper portion of the battery pack is formed with the step corresponding to the step portion of the floor panel.

The cross portion coupling between the pair of rockers is thus formed at the vehicle rear side of the step portion of the floor panel and at the vehicle lower side of the floor. Accordingly, in a vehicle frontal collision, for example, inertial force toward the vehicle front side acts on the battery pack that has a large mass. However, load is able to be dispersed into the rockers through the cross portion provided at the step portion positioned at the vehicle front side of the battery pack. Namely, deformation to the vehicle cabin and damage to the battery pack as a result of a collision may be prevented or suppressed.

The vehicle lower section structure according to the aspect further including a seat rail for attaching a seat that is disposed on the floor panel and extends along the vehicle front-rear direction, wherein the cross portions of the cross member are provided at positions corresponding to a front end of and a rear end of the seat rail, the cross portions being coupled to the seat rail.

In this configuration, the seat rail that extends along the vehicle front-rear direction is provided at the floor panel for attaching a seat thereto. Further, respective of the cross portions are provided so as to be coupled to the front end of the seat rail and the rear end of the seat rail.

Thus, in a vehicle frontal collision, for example, load from the battery pack toward the vehicle front side acting on the cross portion at the vehicle rear side of the floor panel is not only dispersed into the rockers from the cross portion at the vehicle rear side, but also dispersed into the rockers from the cross portion at the vehicle rear side through the seat rail and the cross portion at the vehicle front side. This enables load acting on the battery pack as a result of a collision to be further dispersed, enabling deformation to the vehicle cabin and damage to the battery pack as a result of a collision to be prevented or suppressed.

The vehicle lower section structure according to the aspect further including a coupling member disposed at the vehicle front side of the battery pack and extending along the vehicle front-rear direction, wherein a rear end of the coupling member is coupled to the cross portion that is positioned at a front end of the battery pack, and a front end of the coupling member is coupled to a frame member of a vehicle front section.

In this configuration, the coupling member extending along the vehicle front-rear direction is provided at the vehicle front side of the battery pack. The front end of the coupling member is coupled to the frame member of the vehicle front section, and the rear end of the coupling member is coupled to the cross portion positioned at the front end of the battery pack.

Thus, in a vehicle frontal collision, for example, load from the battery pack toward the vehicle front side acting on the cross portion positioned at the front end of the battery pack is dispersed into the vehicle front section frame member through the coupling member. Namely, load as a result of a collision acting on the battery pack may be further dispersed, enabling deformation to the vehicle cabin and damage to the battery pack as a result of a collision to be prevented or suppressed.

Thus, a vehicle lower section structure according to the above aspect may disperse load acting on a battery pack in a vehicle collision.

### BRIEF DESCRIPTION OF THE DRAWINGS

An exemplary embodiment of the present disclosure will be described in detail based on the following figures, wherein:

FIG. 1 is a schematic plan view illustrating a vehicle cabin of a vehicle applied with a vehicle lower section structure according to an exemplary embodiment of the present disclosure;

FIG. 2 is a schematic vertical cross-section illustrating a vehicle cabin of a vehicle applied with a vehicle lower section structure according to an exemplary embodiment;

FIG. 3 is a vertical cross-section illustrating a vehicle lower section structure according to an exemplary embodiment;

FIG. 4 is a cross-section taken along line A-A in FIG. 3;

FIG. 5 is a cross-section taken along line B-B in FIG. 3;

FIG. 6 is a cross-section taken along line C-C in FIG. 3;

FIG. 7 is a cross-section taken along line D-D in FIG. 3;

FIG. 8 is a perspective view illustrating relevant portions of a vehicle lower section structure according to an exemplary embodiment;

FIG. 9 is a plan view illustrating relevant portions of a vehicle lower section structure according to an exemplary embodiment; and

FIG. 10 is a schematic diagram illustrating load transmission paths in a vehicle lower section structure according to an exemplary embodiment.

### DETAILED DESCRIPTION

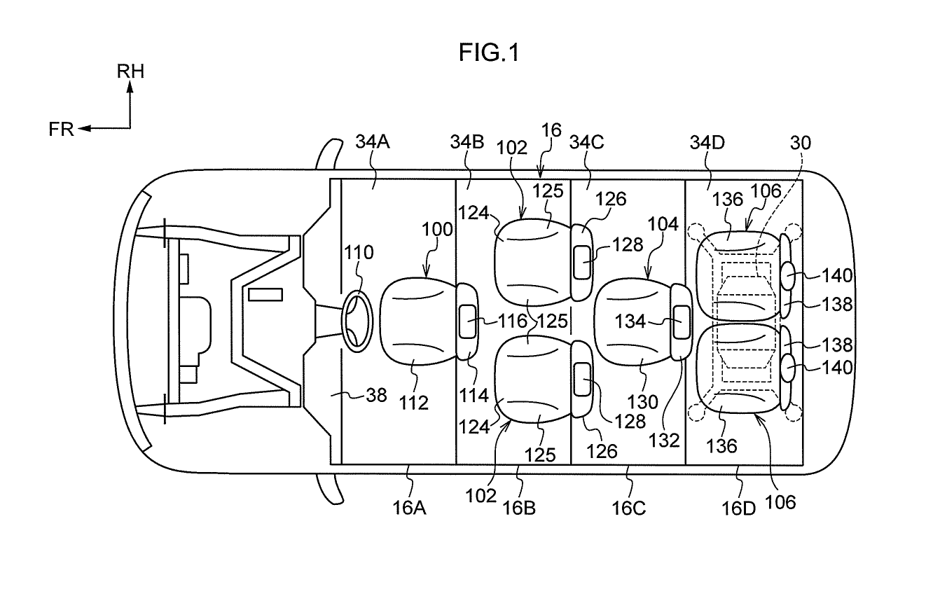

Explanation follows regarding an exemplary embodiment of a vehicle lower section structure according to the present disclosure, with reference to FIG. 1 to FIG. 10. Note that the arrow FR, the arrow UP, and the arrow RH in the drawings respectively indicate the vehicle front, the vehicle upper side, and right in a vehicle width direction.

Overall Configuration

Explanation follows regarding a vehicle lower section structure 10 according to the exemplary embodiment that is applied to a vehicle 12. The vehicle 12 is a minivan and is basically configured with left-right symmetry.

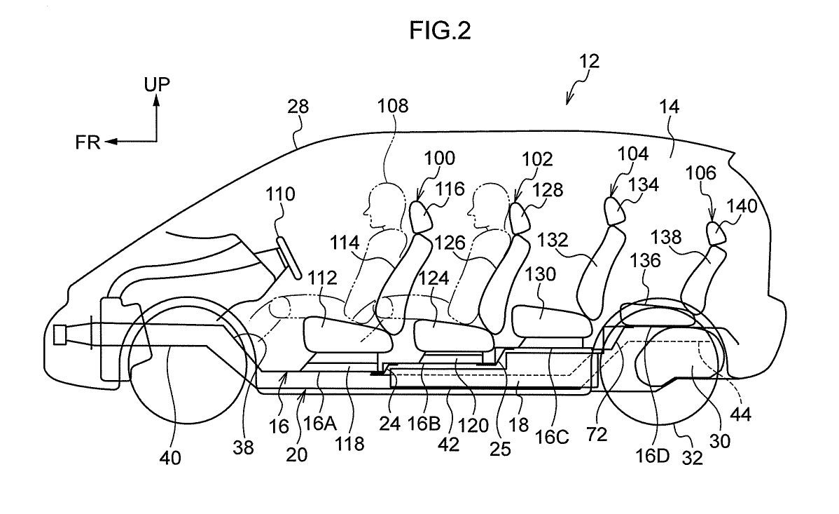

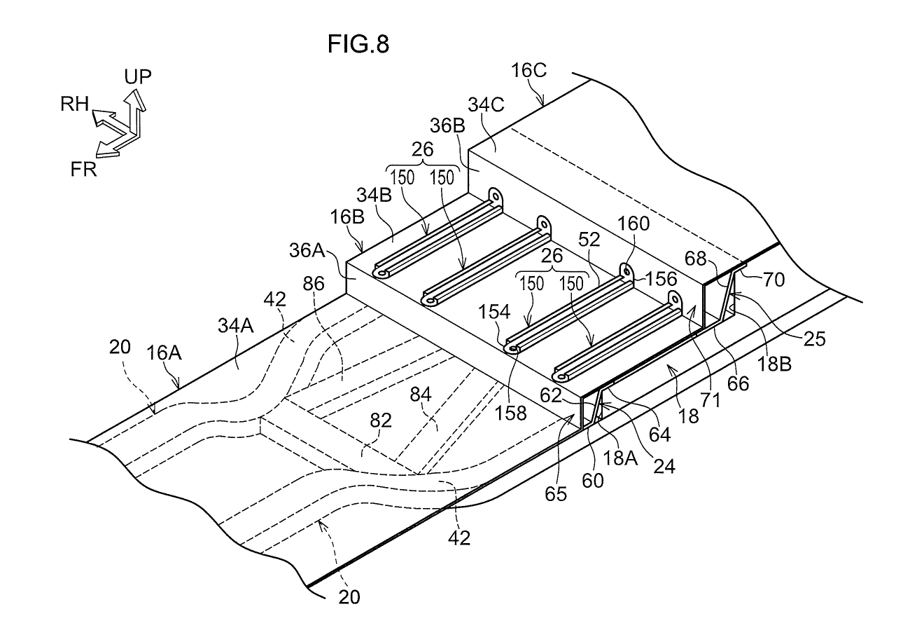

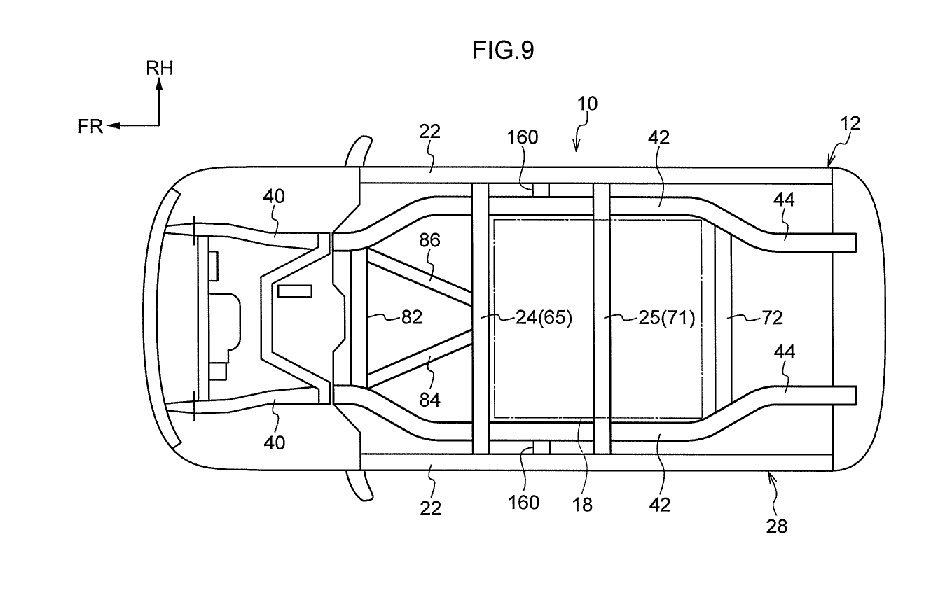

As illustrated in FIG. 2, the vehicle lower section structure 10 includes a floor panel 16, a battery pack 18, side members 20, rockers 22, cross members 24, 25, and lower rails 26. The floor panel 16 configures a vehicle cabin 14. The battery pack 18 is installed under the floor panel 16. Each side member 20 is a vehicle frame member running continuously from a front end to a rear end of the vehicle and that is disposed below the floor panel 16. At a lower side of both vehicle width direction ends of the vehicle 12 (vehicle cabin 14), the rockers 22 (see FIG. 9) extend along a vehicle front-rear direction. At the lower side of the floor panel 16, the cross members 24, 25 each couple the pair of rockers 22 together. The lower rails 26 (see FIG. 8) configure seat rails provided on the floor panel 16.

First, explanation follows regarding an outline of the vehicle 12 to which the vehicle lower section structure 10 is applied. The vehicle 12 includes a vehicle body 28 containing the vehicle cabin 14, and a motor 30 and the battery pack 18 that are attached to the vehicle body 28. The motor 30 is driven by receiving power supplied from the battery pack 18. Drive force generated in the motor 30 is transmitted to rear wheels 32 (drive wheels) through a gearbox or the like, not illustrated in the drawings. Namely, the vehicle 12 travels basically by the rear wheels 32 being driven using the motor 30. An engine is not installed in the vehicle 12, nor is an engine room provided to the vehicle 12.

Floor Panel

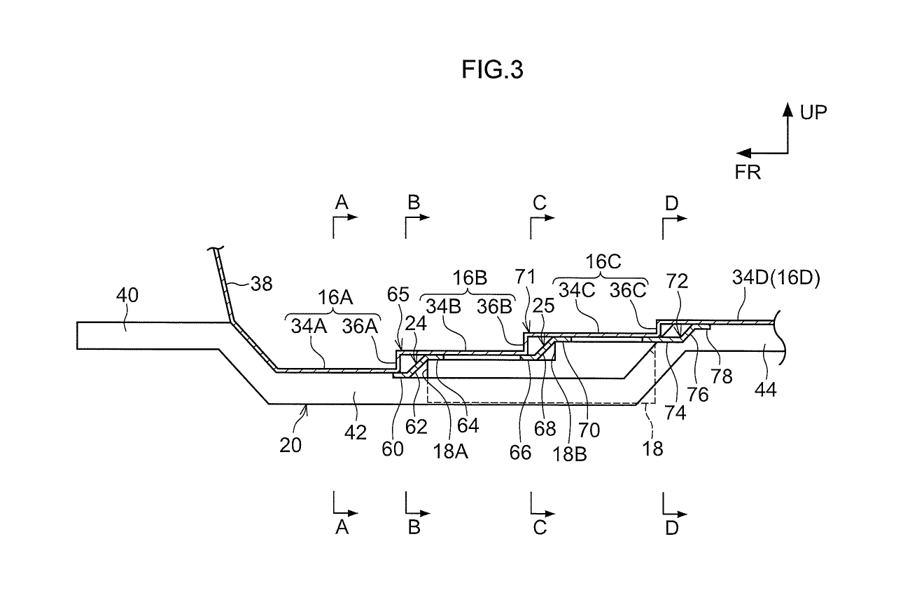

Next, explanation follows regarding the floor panel 16 configuring a floor surface of the vehicle cabin 14. As illustrated in FIG. 1 and FIG. 3, the floor panel 16 is formed by pressing sheet steel. A first panel 16A, a second panel 16B, a third panel 16C, and a fourth panel 16D are configured disposed in this sequence from the vehicle front in plan view.

As illustrated in FIG. 1 and FIG. 2, the first panel 16A configures a portion of the floor panel 16 extending from the vehicle front side of the floor panel 16 for a length approximately one fourth the vehicle front-rear direction length of the floor panel 16. As illustrated in FIG. 1 and FIG. 3, the first panel 16A includes a plate shaped first floor 34A having a substantially rectangular shape in plan view, and a first vertical wall 36A that extends from a vehicle rear end of the first floor 34A toward the vehicle upper side. A vehicle front portion of the first panel 16A (first floor 34A) is connected to a dashboard 38. A non-illustrated steering mechanism is disposed at a vehicle lower side of the dashboard 38.

The second panel 16B configures a portion of the floor panel 16 extending from a vehicle rear side of the first panel 16A for approximately one fourth the vehicle front-rear direction length of the floor panel 16. As illustrated in FIG. 1 and FIG. 3, the second panel 16B includes a plate shaped second floor 34B that extends from an upper end of the first vertical wall 36A of the first panel 16A toward the vehicle rear side and that has a substantially rectangular shape in plan view, and a second vertical wall 36B that extends from a vehicle rear end of the second floor 34B toward the vehicle upper side. Namely, the second floor 34B of the second panel 16B is formed higher than the first floor 34A of the first panel 16A by a height amount corresponding to the vehicle vertical direction height of the first vertical wall 36A.

The third panel 16C configures a portion of the floor panel 16 extending from a vehicle rear side of the second panel 16B for approximately one fourth of the vehicle front-rear direction length of the floor panel 16. As illustrated in FIG. 1 and FIG. 3, the third panel 16C includes a plate shaped third floor 34C that extends from an upper end of the second vertical wall 36B of the second panel 16B toward the vehicle rear side and that has a substantially rectangular shape in plan view, and a third vertical wall 36C that extends from a vehicle rear end of the third floor 34C toward the vehicle upper side. Namely, the third floor 34C of the third panel 16C is formed higher than the second floor 34B of the second panel 16B by a height amount corresponding to the vehicle vertical direction height of the second vertical wall 36B.

The fourth panel 16D configures a portion of the floor panel 16 extending from a vehicle rear side of the third panel 16C for approximately one fourth the vehicle front-rear direction length of the floor panel 16. As illustrated in FIG. 1 and FIG. 3, the fourth panel 16D includes a plate shaped fourth floor 34D that extends from an upper end of the third vertical wall 36C of the third panel 16C toward the vehicle rear side and that has a substantially rectangular shape in plan view. Namely, the fourth floor 34D of the fourth panel 16D is formed higher than the third floor 34C of the third panel 16C by a height amount corresponding to the vehicle vertical direction height of the third vertical wall 36C. Note that as illustrated in FIG. 1 and FIG. 2, the motor 30 is disposed at the vehicle lower side of the fourth panel 16D.

Note that the first vertical wall 36A, the second vertical wall 36B, and the third vertical wall 36C correspond to step portions.

Battery Pack

The battery pack 18 is disposed at the vehicle lower side of the second panel 16B and the third panel 16C. The battery pack 18 is configured by plural battery modules housed inside a case. As illustrated in FIGS. 2 and 3, the battery pack 18 is formed with a stepped profile having greater thickness at a portion at the vehicle rear side than the thickness at a portion at the vehicle front side as viewed along the vehicle width direction. Namely, the battery pack 18 has a shape substantially corresponding to (or following) the shape of a space at a vehicle lower side of the second panel 16B and third panel 16C.

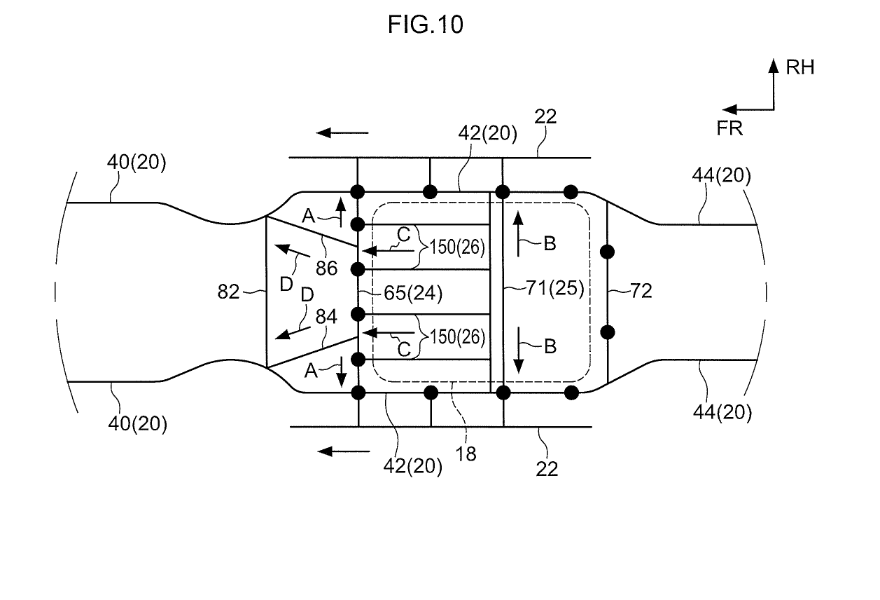

As illustrated in FIG. 9 and FIG. 10, the two vehicle width direction ends of the battery pack 18 are supported by floor under-reinforcements 42 (side members 20), described later, using non-illustrated brackets. The two vehicle front-rear direction ends of the battery pack 18 are respectively attached to cross members 24, 72, described later, via non-illustrated brackets. Note that the black circles in FIG. 10 indicate positions attached to (supported by) brackets. As illustrated in FIG. 3 and FIG. 8, because the battery pack 18 is attached to the vehicle body in this manner, a front face 18A on the lower-step side of the battery pack 18 is positioned at the vehicle rear side of the cross member 24, described later, and a front face 18B on the upper-step side of the battery pack 18 is positioned at the vehicle rear side of the cross member 25, described later. The front face 18B corresponds to a step corresponding to the second vertical wall 36B of the floor panel 16.

Side Member

Next, explanation follows regarding the side members 20. As illustrated in FIG. 2 and FIG. 9, the side members 20 are formed as a left and right pair of vehicle frame members extending continuously along the vehicle front-rear direction from a front end to a rear end of the vehicle body 28. Each side member 20 includes: a front side-member 40 at the vehicle front side; floor under-reinforcement 42 extending beneath the vehicle cabin 14, with the floor under-reinforcement 42 being at a position at the vehicle rear side of the front side-member 40 and lower than the front side-member 40; and a rear side-member 44 that extends to the vehicle rear side, with the rear side-member 44 being at a position at the vehicle rear side of the floor under-reinforcement 42 and higher than the floor under-reinforcement 42.

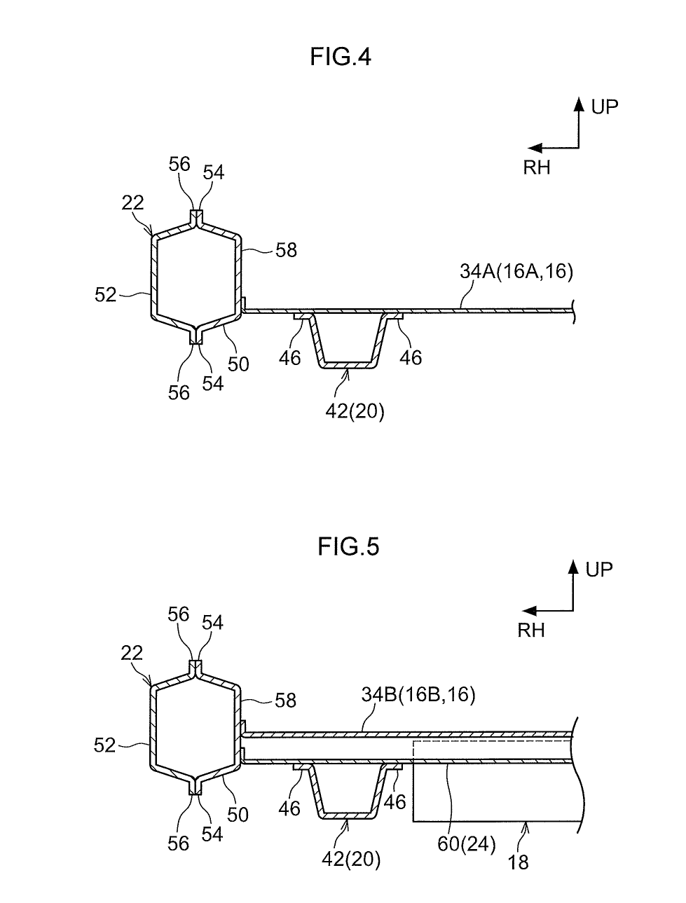

As illustrated in FIG. 3, the floor under-reinforcement 42 is configured supporting the first floor 34A, and the rear side-member 44 is configured supporting the fourth floor 34D. Namely, as illustrated in FIG. 4, the floor under-reinforcement 42 has a hat shaped cross-section profile open to the vehicle upper side, and flanges 46 at the two ends of the floor under-reinforcement 42 are joined to a lower face of the first floor 34A such that the floor under-reinforcement 42 forms a closed cross-section with the first floor 34A. Further, as illustrated in FIG. 7, the rear side-member 44 is positioned at the vehicle lower side of the fourth floor 34D. The rear side-member 44 has a hat shaped cross-section profile open to the vehicle upper side, and flanges 48 at the two ends of the rear side-member 44 are joined to a lower face of the fourth floor 34D such that the rear side-member 44 forms a closed cross-section with the fourth floor 34D.

Further, as illustrated in FIG. 9, a vehicle width direction spacing between the pair of floor under-reinforcements 42 is configured so as to broaden at the vehicle front side and to narrow again at the vehicle rear side. The battery pack 18 is installed between the broadened portions of the floor under-reinforcements 42.

Rocker

Explanation follows regarding the rockers 22. As illustrated in FIG. 9, the rockers 22 are formed extending along the vehicle front-rear direction at both vehicle width direction ends of the vehicle 12 (vehicle cabin 14). As illustrated in FIG. 4 (illustrating one side only), each rocker 22 includes an inner rocker 50 disposed at a vehicle width direction inner side and having a hat shaped cross-section open to a vehicle width direction outer side, and an outer rocker 52 disposed at the vehicle width direction outer side and having a hat shaped cross-section open to the vehicle width direction inner side. A pair of flanges 54 of the inner rocker 50 are respectively joined to a pair of flanges 56 of the outer rocker 52, thereby forming a closed cross-section.

Vehicle width direction ends of the first floor 34A, the second floor 34B, and the third floor 34C of the floor panel 16 are respectively joined to a lower portion, a mid-portion, and an upper portion of side walls 58 of the respective rockers 22 (inner rockers 50, see FIG. 4 to FIG. 6).

As illustrated in FIG. 9, coupling members 160 are also provided between the respective floor under-reinforcements 42 and rockers 22.

Cross Member

Next, explanation follows regarding the cross member 24 disposed at the vehicle rear side of the first vertical wall 36A and vehicle lower side of the second floor 34B. As illustrated in FIG. 3, the cross member 24 is formed with a substantially crank shaped cross-section as viewed along the vehicle width direction, and extends along the vehicle width direction from the rocker 22 on one vehicle width direction side to the rocker 22 on the other vehicle width direction side (see FIG. 9). As illustrated in FIG. 3, the cross member 24 includes a leading end 60 extending along the vehicle front-rear direction, an inclined portion 62 extending from a rear end of the leading end 60 toward the vehicle upper side on progression toward the vehicle rear side, and a rear end 64 extending from a rear end of the inclined portion 62 toward the vehicle rear side. The leading end 60 is joined to a lower face of the rear end of the first floor 34A and the rear end 64 is joined to a lower face on a front side of the second floor 34B. A closed cross-section is thereby formed by the first vertical wall 36A of the first panel 16A, the second floor 34B of the second panel 16B, and the cross member 24. Namely, at a vehicle lower side of the second floor 34B and vehicle rear side of the first vertical wall 36A, a closed cross-section is formed extending along the vehicle width direction. The first vertical wall 36A, the front end of the second floor 34B, and the cross member 24 that together configure this closed cross-section are referred to as a cross portion 65.

As illustrated in FIG. 5, the two vehicle width direction ends of the cross member 24 are respectively joined to lower portions of the side walls 58 of the inner rockers 50 of the rockers 22. The flanges 46, 46 of the floor under-reinforcement 42 are joined to the leading end 60 of the cross member 24, such that the leading end 60 is supported by the floor under-reinforcement 42.

Next, explanation follows regarding the cross member 25 disposed at the vehicle rear side of the second vertical wall 36B and vehicle lower side of the third floor 34C. As illustrated in FIG. 3, the cross-section profile of the cross member 25 as viewed along the vehicle width direction is substantially the same as that of the cross member 24. Namely, the cross member 25 includes a leading end 66, an inclined portion 68, and a rear end 70. The leading end 66 is joined to a lower face of the rear end of the second floor 34B and the rear end 70 is joined to a lower face at a front side of the third floor 34C, such that a closed cross-section is formed by the second vertical wall 36B of the second panel 16B, the third floor 34C of the third panel 16C, and the cross member 25. Namely, at a vehicle lower side of the third floor 34C and vehicle rear side of the second vertical wall 36B, a closed cross-section is formed extending along the vehicle width direction. The second vertical wall 36B, the front end of the third floor 34C, and the cross member 25 that configure this closed cross-section are referred to as a cross portion 71.

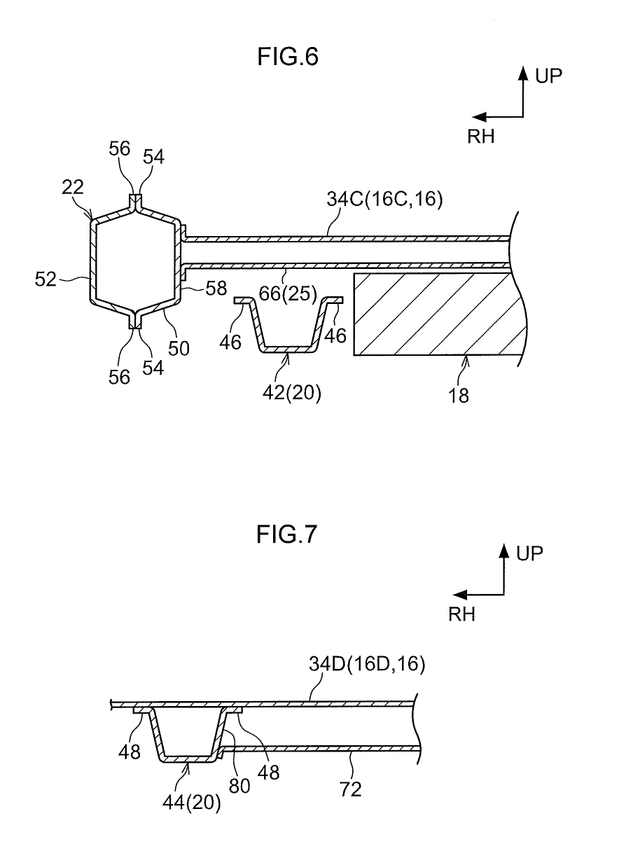

Further, as illustrated in FIG. 6, both vehicle width direction ends of the cross member 25 are joined to vertical direction centers of the side walls 58 of the inner rockers 50 of the respective rockers 22. Note that the cross member 25 differs from the cross member 24 in that the cross member 25 is separated from the floor under-reinforcements 42 in the vehicle vertical direction and is not supported by the floor under-reinforcements 42.

Next, explanation follows regarding a cross member 72 provided at a vehicle rear side of the third vertical wall 36C and vehicle lower side of the fourth floor 34D. As illustrated in FIG. 3, the cross member 72 has a closed cross-section profile as viewed along the vehicle width direction that is substantially the same as that of the cross members 24, 25. The cross member 72 includes a leading end 74, an inclined portion 76, and a rear end 78. The leading end 74 is joined to a lower face of the rear end of the third floor 34C, and the rear end 78 is joined to a lower face of a front side of the fourth floor 34D. A closed cross-section is thereby formed by the third vertical wall 36C of the third panel 16C, the fourth floor 34D of the fourth panel 16D, and the cross member 72.

Note that as illustrated in FIG. 7, both vehicle width direction ends of the cross member 72 are joined to a side face 80 of the rear side-member 44, thereby coupling together the left and right pair of rear side-members 44.

Moreover, as illustrated in FIG. 8 and FIG. 9, a front cross member 82 is formed at a vehicle front end (further to the vehicle front side than the first vertical wall 36A (cross portion 65)) of the floor under-reinforcements 42 (side members 20), and the front cross member 82 couples the left and right pair of floor under-reinforcements 42 together. Coupling members 84, 86 are provided respectively coupling the two vehicle width direction ends of the front cross member 82 to the cross member 24. The coupling members 84, 86 are disposed obliquely from the front cross member 82 toward the vehicle width direction inner side on progression toward the vehicle rear side as viewed in plan view.

Vehicle Seats

Next, explanation follows regarding the lower rails 26 and regarding the arrangement of vehicle seats disposed on the floor panel 16.

In the present exemplary embodiment, a first seat 100, second seats 102, a third seat 104, and fourth seats 106 are respectively disposed on the first floor 34A to the fourth floor 34D.

As illustrated in FIG. 1 and FIG. 2, the first seat 100 is configured by a driving seat in which a driver 108 sits, and a steering wheel 110 is disposed at a vehicle front side of the first seat 100. The first seat 100 is configured including a first seat cushion 112 supporting the buttocks and thighs of the driver 108, a first seatback 114 supporting the back of the driver 108, and a first headrest 116 supporting the head of the driver 108. The first headrest 116 is supported by a vehicle upper end of the first seatback 114 so as to be capable of moving up and down, and the first seatback 114 is tiltably supported by a vehicle rear end of the first seat cushion 112. The first seat 100 is attached to the first floor 34A through a slide mechanism 118 and a rotation mechanism.

Each slide mechanism 118 includes a left and right pair of lower rails, a left and right pair of upper rails corresponding to the lower rails, and an actuator, none of which are illustrated. The lower rails have their length directions along the vehicle front-rear direction are respectively fixed to the first floor 34A. On the other hand, the left and right upper rails are supported so as to capable of sliding in the vehicle front-rear direction with respect to the respective lower rails, and are attached to the first seat cushion 112. Using drive force from the actuator, the first seat 100 and the upper rails are capable of moving in the vehicle front-rear direction relative to the lower rails, and consequently to the first floor 34A.

Further, the first seat 100 is disposed at a vehicle width direction center in the vehicle cabin 14, more specifically, at a vehicle width direction central portion of the first panel 16A. Thus, lopsided load from the weight of the driver 108 is not liable to arise in the vehicle 12 during travel.

Each second seat 102 on which an occupant 122 sits includes a second seat cushion 124, a second seatback 126, and a headrest 128, and is basically configured similarly to the first seat 100. Each second seat 102 is provided with a slide mechanism 120.

Further, the second seats 102 are configured in a left and right pair disposed on the second panel 16B at a predetermined spacing from each other so as to be symmetrical about a center line of the vehicle 12 extending along the vehicle front-rear direction. Namely, the second seats 102 are disposed at the vehicle rear side of the first seat 100, in a state separated from each other in the vehicle width direction.

Moreover, the second seats 102 are each disposed adjacent to the first seat 100 such that the second seat cushions 124 do not overlap the first seat cushion 112 as viewed along the vehicle width direction. Moreover, the second seats 102 are disposed such that for each second seat 102, at least a vehicle width direction inner portion, more specifically a vehicle width direction inner portion of a pair of side supports 125 bulging toward the vehicle upper side of the second seat cushion 124, overlaps the first seat 100 as viewed along the vehicle front-rear direction.

The third seat 104 is configured for use by an occupant 122, and is configured similarly to the second seats 102. The third seat 104 is configured including a third seat cushion 130, a third seatback 132, and a headrest 134.

Further, the third seat 104 is disposed at the vehicle rear side of the second seats 102, adjacent to the second seats 102 such that the third seat cushion 130 does not overlap the second seat cushions 124 as viewed along the vehicle width direction. The vehicle width direction position of the third seat 104 is set at a vehicle width direction central portion of the third panel 16C such that the third seat 104 overlaps the first seat 100 as viewed along the vehicle front-rear direction. Note that the spacing between the second seats 102 described above is set so as to be a length that accommodates the legs of an occupant 122 in a state in which the occupant 122 is seated in the third seat 104.

The fourth seats 106 are configured for use by occupants 122, and are configured similarly to the second seats 102. The fourth seats 106 are each configured including a fourth seat cushion 136, a fourth seatback 138, and a headrest 140.

The fourth seats 106 are configured in a left and right pair disposed on the fourth panel 16D, namely at the vehicle rear side of the third seat 104, in a state in which the fourth seats 106 are connected to each other in the vehicle width direction so as to be symmetrical about the center line of the vehicle 12 extending along the vehicle front-rear direction. More specifically, as also illustrated in FIG. 1 and FIG. 2, the fourth seats 106 are adjacent to the third seat 104 such that the fourth seat cushions 136 do not overlap the third seat cushion 130 as viewed along the vehicle width direction. Additionally, the fourth seats 106 are respectively disposed such that the fourth seat cushions 136 are close together and such that for each fourth seat 106, at least a portion further to the vehicle width direction outer side than a vehicle width direction central portion of the fourth seat 106 does not overlap the third seat 104 as viewed along the vehicle front-rear direction. Note that the fourth seats 106 may be disposed such that the fourth seat cushions 136 are touching each other, or may be disposed such that the fourth seat cushions 136 are separated from each other in the vehicle width direction.

Lower Rails

As illustrated in FIG. 8, the lower rails 26 configuring the slide mechanisms 120 are disposed on the second floor 34B. The lower rails 26 are configured by a left and right pair of rails 150, 150. Each rail 150 includes a rail body 152 extending along the vehicle front-rear direction on the second floor 34B, a front attachment portion 154 formed on the vehicle front end of the rail body 152, and a rear attachment portion 156 formed extending from a vehicle rear end of the rail body 152 toward the vehicle upper side. Insertion holes 158, 160 for fasteners are formed in the front attachment portion 154 and the rear attachment portion 156, respectively. Note that to avoid complicating the drawings, reference numerals are only shown for the configuration elements of one of the rails 150, and those of the other rails 150 are omitted.

Accordingly, by inserting and fastening fasteners into the insertion holes in the front attachment portions 154 and insertion holes in the vehicle front end side of the second floor 34B, not illustrated in the drawings, the front attachment portions 154 are fastened to the front end of the second floor 34B. Namely, the front attachment portions 154 are fastened to the cross portion 65. Further, by inserting and fastening fasteners into the insertion holes in the rear attachment portions 156 and insertion holes in the second vertical wall 36B, not illustrated in the drawings, the rear attachment portions 156 are fastened to the second vertical wall 36B. Namely, the rear attachment portions 156 are fastened to the cross portion 71. The lower rails 26 couple the cross portion 71 to the cross portion 65 in this manner.

### Operation and Effects of the Exemplary Embodiment

Next, explanation follows regarding operation and effects of the present exemplary embodiment.

The battery pack 18 mounted to the vehicle 12 is formed in a stepped profile substantially corresponding to (following) the shape of the second panel 16B and third panel 16C, and is disposed at the vehicle lower side of the second floor 34B and the third floor 34C. This enables a capacity for the battery pack 18 housing the battery modules to be secured at the vehicle lower side of the floor panel 16.

On the other hand, in a vehicle frontal collision, a large inertial force (load) toward the vehicle front acts on a battery pack 18 having a comparatively large mass. Thus, as illustrated in FIG. 8, the front face 18A of the lower step of the battery pack 18 abuts the cross member 24 (inclined portion 62) of the cross portion 65, and load from the battery pack 18 is dispersed into the rocker 22 through the cross member 24 (cross portion 65) (see arrows A in FIG. 10).

Further, as illustrated in FIG. 3 and FIG. 8, in a vehicle frontal collision, the front face 18B of the upper step of the battery pack 18 abuts the cross member 25 (inclined portion 68) of the cross portion 71, and load from the battery pack 18 is dispersed into the rockers 22 through the cross member 25 (cross portion 71) (see arrows B in FIG. 10).

Moreover, the cross portion 65 and the cross portion 71 are coupled together by the lower rails 26. Thus, in a vehicle frontal collision, load input to the cross portion 71 (cross member 25) from the front face 18B of the upper step of the battery pack 18 is dispersed in the rockers 22 through the lower rail 26 and cross portion 65 (cross member 24, see arrows C and arrows A in FIG. 10).

Moreover, at the vehicle front side of the cross member 24 (cross portion 65), the front cross member 82 is disposed coupling together the left and right pair of floor under-reinforcements 42, and the front cross member 82 and the cross portion 65 are coupled together by the coupling members 84, 86. Accordingly, in a frontal collision of the vehicle 12, load from the battery pack 18 input to the cross portion 65 (cross member 24) is dispersed in the front cross member 82 and the floor under-reinforcements 42 through the coupling members 84, 86 (see arrows D in FIG. 10).

Thus, load acting on the battery pack 18 during a vehicle frontal collision is dispersed in the rockers 22 through the cross members 24, 25 (cross portion 65, 71), thereby preventing or suppressing deformation of the vehicle cabin 14 (floor panel 16) as well as damage to the battery pack 18.

Further, in a vehicle side collision, collision load input from the rocker 22 side on one vehicle width direction end side is dispersed in the rocker 22 on the other vehicle width direction end side through the cross members 24, 25 (cross portions 65, 71). This prevents or suppresses deformation of the vehicle cabin 14 (floor panel 16) as well as damage to the battery pack 18.

In particular, the cross portions 65, 71 are formed at the rear of the first vertical wall 36A and the rear of the second vertical wall 36B configuring the floor panel 16 into steps. This enables a decrease in the capacity of the battery pack 18 disposed below the second floor 34B and the third floor 34C as a result of the placement of the cross members 24, 25 to be suppressed to a minimum. Accordingly, there is no need to change (or to raise) the vehicle height in order to provide the cross portion 65, 71 while securing the capacity of the battery pack 18.

Further, the cross portion 65 and the cross portion 71 are configured coupled together by the lower rails 26, enabling load from the battery pack 18 (the front face 18B) input to the cross portion 71 to be dispersed in the cross portion 65 through the lower rails 26 during a vehicle frontal collision.

Moreover, load input to the cross portion 65 is dispersed in the rockers 22, and dispersed in the front ends of the floor under-reinforcements 42 and in the front side-members 40 continuous to the vehicle front sides of the floor under-reinforcements 42 through the coupling members 84, 86, and front cross member 82.

Accordingly, deformation of the vehicle cabin 14 (floor panel 16) and damage to the battery pack 18 is even further prevented or suppressed.

In particular, the cross portions 65, 71 are formed at the step portions formed to the floor panel 16. Thus, by merely attaching the front attachment portions 154 of existing lower rails 26 to the front end of the second floor 34B and attaching the rear attachment portions 156 of the existing lower rails 26 to the second vertical wall 36B, the lower rails 26 may be used to couple the cross portion 65 to the cross portion 71.

The battery pack 18 is attached to the floor under-reinforcements 42 and the cross members 24, 25, and the left and right pair of floor under-reinforcements 42 are coupled to the cross member 24 and cross member 72. Further, the cross portion 65 (cross member 24) and the cross portion 71 (cross member 25) are respectively coupled between the rockers 22. Moreover, the cross portion 65 (cross member 24) and the cross portion 71 (cross member 25) are coupled together by the lower rails 26. This enables torsional rigidity of the vehicle body 28 and surface rigidity of the floor panel 16 to be improved.

### OTHER

Note that in the present exemplary embodiment, configuration is made in which the rails 150 of the lower rails 26 are attached to the floor panel 16 configuring the cross portions 65, 71 through the front attachment portions 154 and the rear attachment portions 156, and the rails 150 are coupled to the cross members 24, 25 configuring the cross portions 65, 71. However, the disclosure is not limited thereto and configuration may be made in which the front attachment portion 154 and rear attachment portion 156 are directly fastened to the cross members 24, 25 with the floor panel 16 interposed therebetween.

Further, in the present exemplary embodiment, the first vertical wall 36A to the third vertical wall 36C, these being step portions, are provided such that the floor panel 16 is configured as a four-step floor. However, the number of steps is not limited thereto. It is sufficient that a front face of the battery pack 18 abuts at least one vertical wall (step portion) during a vehicle frontal collision.

Moreover, in the present exemplary embodiment, configuration may be made in which the front end of the battery pack 18 extends to the lower side of the first panel 16A.

Further, in the present exemplary embodiment, the cross members 24, 25 are respectively disposed below the floor panel 16 and at the vehicle rear side of the vertical walls 36A, 36B. However, configuration may be made in which cross members 24, 25 are respectively disposed above the floor panel 16 and at the vehicle front side of the vertical walls 36A, 36B.

Moreover, explanation has been given in which the present exemplary embodiment is applied to an electric automobile having neither an engine nor an engine room. However, there is no limitation thereto. Application may be made to a hybrid vehicle including an engine.

What is claimed is:

1. A vehicle lower section structure comprising:
rockers that are configured to be disposed at both vehicle width direction ends of a vehicle and that extend along a vehicle front-rear direction;
a floor panel that comprises a plurality of floors in which a vehicle rear side thereof set higher than a vehicle front side thereof in a vehicle vertical direction, and a step portion formed between the floors that are adjacent to each other in the vehicle front-rear direction;
a battery pack that is configured to be installed at a vehicle lower side of the floors, an upper portion of the battery pack comprising a step corresponding to each of the step portions of the floor panel; and
a cross member that forms a cross portion having a closed cross-section together with the step portion and the floor, the cross portion extending along the vehicle width direction and coupling between the rockers.

2. The vehicle lower section structure of claim 1, further comprising a seat rail for attaching a seat that is disposed on the floor panel and extends along the vehicle front-rear direction, wherein the cross portions of the cross member are provided at positions corresponding to a front end of and a rear end of the seat rail, the cross portions being coupled to the seat rail.

3. The vehicle lower section structure of claim 1, further comprising a coupling member disposed at the vehicle front side of the battery pack and extending along the vehicle front-rear direction, wherein a rear end of the coupling member is coupled to the cross portion that is positioned at a front end of the battery pack, and a front end of the coupling member is coupled to a frame member of a vehicle front section.
